(19) United States
(12) Patent Application Publication
(10) Pub. No.: US 2009/0167420 A1
(43) Pub. Date: Jul. 2, 2009

(54) DESIGN STRUCTURE FOR REGULATING THRESHOLD VOLTAGE IN TRANSISTOR DEVICES

(75) Inventor: Edward J. Nowak, Essex Junction, VT (US)

Correspondence Address: SCULLY, SCOTT, MURPHY & PRESSER, P.C., 400 GARDEN CITY PLAZA, Suite 300, GARDEN CITY, NY, 11530, US

(73) Assignee: INTERNATIONAL BUSINESS MACHINES CORPORATION, Armonk, NY (US)

(21) Appl. No.: 11/965,787

(22) Filed: Dec. 28, 2007

(51) Int. Cl. G05F 3/16

(52) U.S. Cl. 327/541; 327/543

(57) ABSTRACT

A circuit and a design structure including the circuit embodied in a machine readable medium are disclosed. The circuit is for regulating a desired value of threshold voltage, Vt, for a given FET transistor device. The circuit is coupled to the FET for regulating the desired value of Vt, by providing a device body voltage, and, that additionally enables control of the voltage at the drain of the FET device independent of the applied body bias voltage. The coupled circuit includes an operational amplifier, or, a second MOS transistor, or, a Zener diode.

This application is related to co-pending and co-assigned U.S. patent application Ser. No. 11/423,506, filed Jun. 12, 2006, currently pending.

### FIELD OF THE INVENTION

The present invention relates generally to semiconductor transistors and design structures including the semiconductor transistors embodied in a machine readable medium, and more particularly, a design structure for regulating threshold voltages in CMOS FET devices.

### DESCRIPTION OF THE PRIOR ART

As known, in conventional static, dynamic, and differential complementary metal oxide semiconductor (CMOS) logic, circuits, and devices, the threshold voltage Vt is that value of voltage applied to the gate that turns the transistor on creating a channel where charge can flow from drain to source (conducting). When the value at the gate is below the threshold voltage Vt, the transistor FET is turned off and ideally there is no current between the drain and the source of the transistor.

Precise control of threshold voltage, Vt, particularly in CMOS technology, has resulted in analog designs making use of body-to-source bias in order to adjust Vt to a desired target value. This has required accurate models and control for the dependence of Vt on body-to-source voltage (Vbs). Furthermore, optimization of the tradeoff between subthreshold leakage and circuit delay, in digital CMOS circuits, similarly requires good control of Vt. Changes from technology, often undergoing changes in parallel to the product design effort, can cause disruptions to product function as a result. Similarly, variations in manufacturing can cause deterioration in the performance of analog or digital circuits that depend on accurate Vt.

One prior art circuit 10 for controlling the Vt of a device is depicted in FIG. 1 that depicts an nMOSFET device M1 having a device body terminal that is connected to its drain terminal. A current source 13 is connected to the drain of the nMOS M1 that provides a threshold current I_Vt, corresponding to the channel current when the gate voltage, Vgs, is equal to the threshold voltage, i.e. Vgs=Vt. A voltage source 15 is coupled to the gate of nMOS M1 that provides the desired threshold voltage, Vt_ref. The direct coupling of the body terminal 20 to the drain 23 of nMOS M1 enables the voltage at the body terminal to increase as the voltage of the drain increases, thereby altering the actual Vt of the NMOS M1. When the voltage at the drain is such that the voltage of the body terminal enables current between drain and source, i.e., threshold current I_Vt, then the device M1 exhibits a threshold voltage, equal to the voltage presented by voltage source 15, i.e. Vt=Vt_ref. The body voltage(=NMOS M1 drain voltage) may be used as a reference voltage signal for the bodies of other transistors similar to M1 in a semiconductor device, and when other similar transistors are operated with this reference voltage applied to their bodies, they, in turn, will also exhibit threshold voltage equal to Vt_ref. Unfortunately, threshold voltage is significantly dependent on FET drain voltage due to an effect known as Drain-Induced Barrier Lowering (DIBL). In the circuit of FIG. 1, the voltage at the drain 23 is equal to the voltage at the body 20, and thus the drain voltage, Vds, is necessarily equal to the body voltage, Vbs, i.e. Vds=Vbs. Thus the drain voltage in this circuit is fixed and inflexible, despite the controllability of the Vt for M1. In many applications, the threshold voltage is of importance at some particular value of drain voltage. For example, in digital CMOS circuits, the speed and leakage of the transistor is largely dependent on the Vt for the condition Vds=Vdd, a condition considerably different from that obtainable from the prior art.

It would thus be highly desirable to provide a simple circuit that provides a body voltage that results in a desired value of Vt, for a given MOSFET type (e.g., nFET or pFET) and provides flexibility in the choice of Vds at which Vt is specified.

It would further be highly desirable to provide a circuit that provides a body voltage that results in a desired value of Vt, for a given MOSFET type (e.g., nFET or pFET), and that additionally enables control of the voltage at the drain of the MOSFET. SUMMARY OF THE INVENTION

The present invention relates generally to a design structure for a circuit for regulating a desired value of Vt, for a given MOSFET type (e.g., nFET or pFET).

The present invention further relates to a circuit for regulating a desired value of Vt, for a given MOSFET type (e.g., nFET or pFET) by a novel circuit providing a device body voltage, and, that additionally enables control of the voltage at the drain of the MOSFET device.

According to one aspect of the invention, there is provided a circuit and method for regulating threshold voltage of a FET transistor device having gate, drain and source terminals and a body terminal, the circuit comprising:

a current source for providing a threshold current bias to the drain terminal of the FET device;

a first voltage source configured to supply a reference threshold voltage to the gate terminal of the FET device; and,

a circuit coupled to the PET device for enabling threshold voltage adjustment of the FET device, the coupled circuit including a first input connected to the drain terminal of the FET device for receiving a voltage at the drain terminal, and having an output for applying a voltage to the body terminal of the FET device in response to the voltage at the drain terminal, the applied voltage to the body enabling adjustment of a threshold voltage of the FET device at the reference threshold voltage, wherein a voltage at the drain terminal of the threshold voltage adjusted FET device is adjustable independent of the body applied voltage.

There is additionally provided a means for distributing the body bias voltage applied at the body terminal of the FET device to other like FET devices provided in an integrated circuit so as to provide a uniform threshold voltage for each of the other like FET devices.

Moreover, the coupled circuit includes means for providing a body current at the FET device that is less than a drain current of the device, whereby a steady state direct current condition in the FET device results when the applied voltage at the body terminal renders the threshold voltage of the FET device equal to the reference threshold value applied at the gate terminal.

In one embodiment of the invention, the coupled circuit comprises an operational amplifier having:

a first, non-inverting, terminal for receiving a voltage at the drain terminal receiving the threshold current bias,

a second, inverting, terminal connected to a second voltage source providing an offset voltage, and

an output terminal connected to the body terminal of the FET device for applying the body bias voltage to the body terminal of the FET device in response to voltage present at the drain terminal.

Further to this first embodiment, the steady state direct current condition in the FET device, a drain terminal voltage equals a value of the offset voltage applied to the second inverting terminal.

In a second embodiment of the invention, the coupled circuit comprises a second FET device including a gate, drain and source terminals and, further including a body bias terminal wherein,

the gate terminal of the second FET device receives a voltage at the drain terminal receiving the threshold current bias;

the drain terminal of the second FET device is connected to a power supply voltage source; and

the source terminal of the second FET device is connected to the body terminal of the first FET device for applying the body bias voltage to the body terminal of the first FET device in response to the voltage present at the drain terminal; and,

the body terminal of the second FET device is connected to a control voltage source used to achieve a desired drain voltage at the first FET device when in the steady state direct current condition.

Further to this second embodiment, the second FET transistor is turned on by a voltage value at the drain terminal of the first FET transistor device greater than the threshold voltage of the second FET device (with respect to the source voltage of the second FET device) as controlled by the control voltage applied at the body terminal of the second FET device, and, in response, the voltage at the source terminal of the second FET transistor increases the voltage applied at the body terminal of the first FET device for adjusting the threshold voltage.

Moreover, at a steady state direct current condition in the first FET device, a drain terminal voltage equals a value of the voltage at the body terminal of the first FET transistor device, plus the threshold voltage of the second FET transistor device, the drain voltage of the first FET device being adjustable due to adjusting the threshold voltage of the second FET device due to the application of the control voltage signal at the body terminal of the second FET transistor.

In an alternate embodiment, the coupled circuit including the second FET device having a gate, drain and source terminals and, further including a body bias terminal is configured such that,

the gate terminal of the second FET device receives a voltage at the drain terminal receiving the threshold current bias;

the drain terminal of the second FET device is connected to a power supply voltage source providing an offset voltage; and

the source terminal of the second FET device is connected to the body terminal of the first FET device for applying the body bias voltage to the body terminal of the first FET device in response to the drain terminal voltage; and,

the source terminal of the second FET device is additionally connected to the body terminal of the second FET device.

In this alternate embodiment, the second FET transistor is turned on by a voltage value at the drain terminal of the first FET transistor device greater than the threshold voltage of the second FET device, and, in response, the voltage at the source terminal of the second FET transistor increases the voltage applied at the body terminal of the first FET device for adjusting the threshold voltage.

In a third embodiment of the invention, the coupled circuit includes a Zener diode device having a determined breakdown voltage, the Zener diode including a first terminal connected to the drain terminal of the FET device and including a second terminal connected to the body bias terminal, wherein a voltage across the Zener diode increases as the voltage at said drain terminal increases in response to received threshold current bias, and in response, the voltage at the body terminal of the FET device increases thereby decreasing the FET device's threshold voltage.

Advantageously, the present invention is applicable to both single gated and double-gated FET transistor devices having front-gate, drain and source terminals and a back-gate terminal whereby the output of the circuit coupled to the FET device applies a voltage to the back-gate terminal of the FET device in response to the drain voltage.

In another aspect of the invention; a design structure is embodied in a machine readable medium, the design structure for regulating threshold voltage of a FET transistor device having gate, drain and source terminals and a body terminal, the design structure comprises: a current source for providing a threshold current bias to said drain terminal of the FET device; a first voltage source configured to supply a reference threshold voltage to the gate terminal of the FET device; and a circuit coupled to said PET device for enabling threshold voltage adjustment of said FET device, said coupled circuit including a first input connected to said drain terminal of said FET device for receiving a voltage at the drain terminal, and having an output for applying a voltage to said body terminal of said FET device in response to said voltage at said drain terminal, said applied voltage to said body enabling adjustment of a threshold voltage of said FET device at the reference threshold voltage, wherein a voltage at said drain terminal of the threshold voltage adjusted FET device is adjustable independent of said body applied voltage.

In a related aspect, the design structure comprises a netlist which describes the circuit and wherein the design structure resides on a storage medium as a data format used for the exchange of layout data of integrated circuits (IC).

In a related aspect, the design structure includes at least one of test data files, characterization data, verification data, or design specifications.

In another aspect of the invention, a design structure is embodied in a machine readable medium, the design structure for regulating threshold voltage of a first FET transistor device having gate, drain and source terminals and a body terminal, said design structure comprises: a current source for providing a threshold current bias to said drain terminal of the first FET device; a first voltage source configured to supply a reference threshold voltage to the gate terminal of the first FET device; and a second FET device coupled to said first FET device for enabling threshold voltage adjustment of said first FET device, said second FET device including a gate, drain and source terminals and, further including a body bias terminal wherein, said gate terminal of said second FET device receives a voltage at said drain terminal of said first FET device receiving said threshold current bias; said drain terminal of said second FET device is connected to a power supply voltage source providing an offset voltage; said source terminal of said second FET device is connected to said body terminal of said first FET device for applying said body bias voltage to said body terminal of said first FET device in response to said voltage present at said drain terminal; and said body terminal of said second PET device is connected to a control voltage source for supplying a voltage used to adjust a threshold voltage of said second FET device, said second FET transistor turning on by a voltage value at said drain terminal of said first FET transistor device greater than a threshold voltage of said second FET device as adjusted by said applied control voltage, and, in response, said voltage at the source terminal of said second FET transistor increases the voltage applied at the body terminal of said first FET device for adjusting said threshold voltage of said first FET device, wherein a voltage at said drain terminal of the threshold voltage adjusted FET device is adjustable independent of said applied voltage at said body terminal of said first FET device.

### BRIEF SUMMARY OF THE DRAWINGS

These and other features and advantages of the present invention will become apparent from the following detailed description of illustrative embodiments thereof which is to be read in connection with the accompanying drawings, in which:

FIG. 1 depicts an nMOSFET device and circuit configuration for regulating the voltage threshold according to the prior art;

FIG. 2 illustrates an nMOSFET device and circuit configuration 25 for regulating threshold voltage according a general embodiment of the invention;

FIG. 3 illustrates an nMOSFET device and circuit configuration 50 for regulating the voltage threshold according to a first embodiment of the invention;

FIGS. 4A and 4B illustrate respective nMOSFET device and circuit configurations 80 and 80′ for regulating the voltage threshold according to a second embodiment of the invention; and,

FIG. 5 depicts an nMOSFET device and circuit configuration 90 for regulating threshold voltage according to a further embodiment of the invention.

FIG. 6 is a flow diagram of a design process used in semiconductor designing, manufacturing and/or testing.

### DETAILED DESCRIPTION OF THE PREFERRED EMBODIMENTS

FIG. 2 illustrates a transistor device T1, e.g., a MOSFET device such as an n-type FET or nMOSFET, and circuit configuration 25 for regulating threshold voltage according a general embodiment of the invention. In FIG. 2, in the general embodiment of a circuit 25 for regulating threshold voltages in the FET device T1, the nFET T1 includes one terminal (e.g., a Source) connected to ground, one terminal (e.g., a Drain) 32 connected to a constant current source 35 providing a device threshold current I_ref current, and a gate terminal 33 connected to a voltage source 40 that may be generated on-chip, or may be supplied from a source external to the chip, providing a desired gate voltage threshold reference V_ref according to a desired application. That is, the nFET T1 is a body-contacted FET, of dimensions W/L, and has its gate set at the target Vt(=V_ref) while the I_ref current source 35 provides the threshold current value of approximately 300 nA×W/L (where W and L are physical width and length dimensions of the device channel) that is forced into the drain/body connection of T1. It is understood that the body current is small compared to the drain current when voltage at the body bias (Vbs ) for transistor T1<0.6V and hence Vbs reaches a DC condition where Vgs=Vt for nFET T1. The T1 drain terminal is connected to an offset circuit 45 having an input terminal 42 receiving an input voltage Vin corresponding to the voltage at the drain of transistor device T1 and an output terminal 43 providing the Vbs body voltage to device T1 at a body terminal 31 for device T1 or a back-gate terminal (not shown). The offset circuit 45 includes a power supply source Vdd that also provides the voltage for the current (I_ref) source circuitry 35.

In operation, as the drain 32 of transistor device T1 builds up voltage as a result of receiving a device threshold current I_ref, the voltage at the Vin input 42 of the offset circuit 45 accordingly rises. As will be described in greater detail herein, the offset circuit 45 comprises circuitry that responds to the voltage at the Vin input 42 to generate the Vbs voltage or Vout voltage 43, shown in FIG. 2, that is used to bias the body 31 (or back-gate) and change the threshold voltage of the transistor device T1, e.g., lowering its threshold voltage Vt. When the body-bias voltage is such that T1 has threshold voltage Vt equal to Vref voltage, nearly all of the I_ref current will flow through the device and the voltage on the drain 32 is stationary (i.e. has achieved a steady-state solution). The voltage value of Vout 43 at which point nearly all of the I_ref current is drawn by the drain of T1, may then be distributed to other like transistors on the die and used to regulate the Vt of those devices. It is understood that the circuit 45 is designed to bias the body of the device so as to provide the adjusted device Vt at the Vref voltage independent of the desired drain voltage 32. That is, according to the invention, the voltage at the drain terminal 32 of the threshold voltage adjusted device T1 is independent of the body applied voltage Vout.

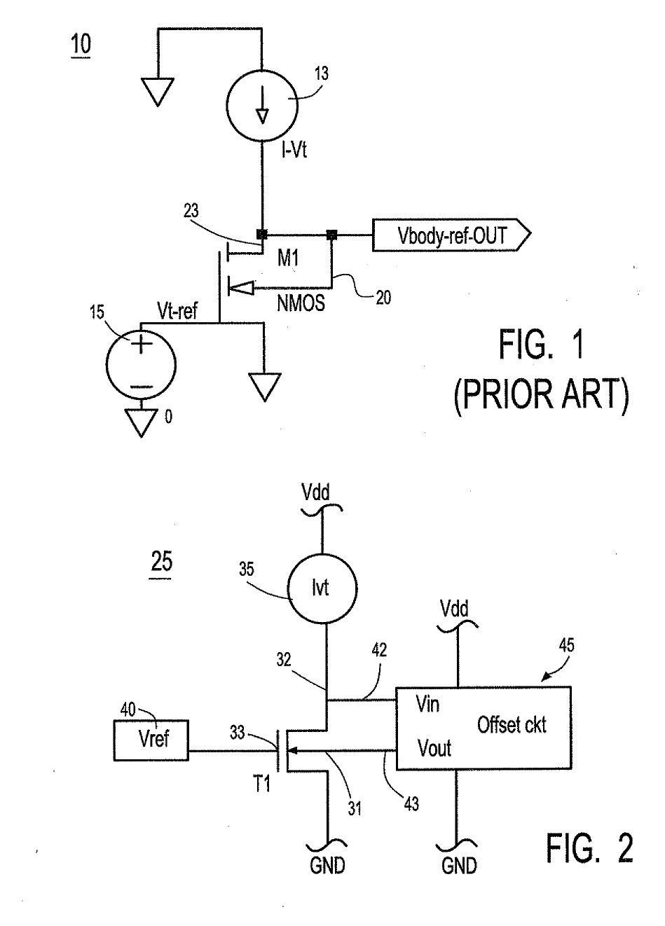

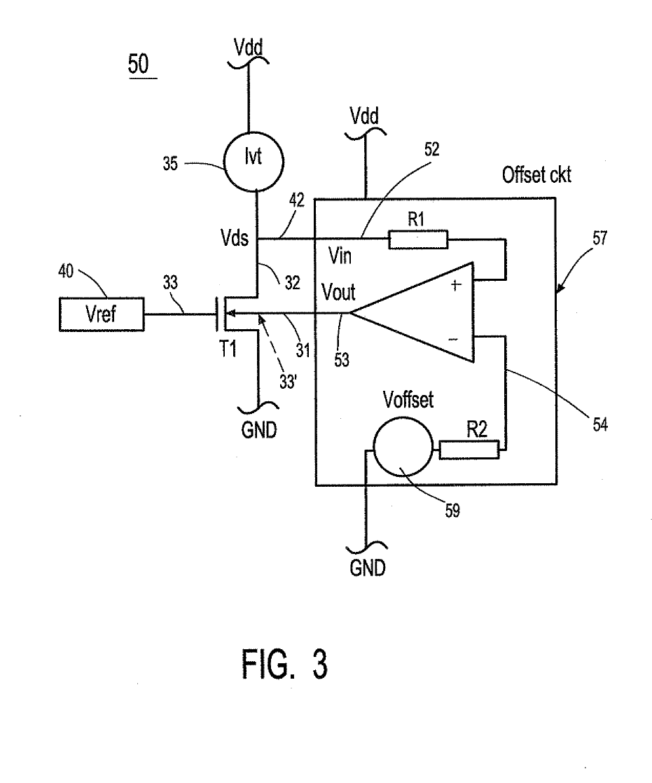

FIG. 3 illustrates a device and circuit configuration 50 for regulating threshold voltage of a MOSFET device according a first embodiment of the invention. In this first circuit configuration, the offset circuit of FIG. 1 comprises a differential operational amplifier circuit 57. In FIG. 3, the circuit 50 for regulating threshold voltages in a CMOS FET device includes a transistor T1, such as the nFET shown in FIG. 2, having one terminal (e.g., a Source) connected to ground, one terminal (e.g., a Drain) 32 connected to a constant current source 35 providing a device threshold current I_ref current, and a gate terminal 33 connected to a voltage source 40, providing a desired gate voltage threshold reference V_ref according to a desired application. The nFET T1 includes a body-contact terminal 31. It further has its gate set at the target Vt(=V_ref) while the I_ref current source provides the threshold current value of approximately 300 nA×W/L that is input to the drain/Vin of T1. It is understood that the current drawn by the Vin terminal is small compared to the drain current (for Vbs<0.6V) and hence the Vbs voltage (voltage at the base-source) reaches a DC (steady state) condition where voltage at the gate terminal Vgs=Vt for nFET T1. The voltage 52 at the T1 drain terminal 32 is input to a non-inverting input Vin of the differential operational amplifier 57 through a first resistor device R1. The inverting input 54 of the differential operational amplifier 57 is connected to a voltage source 59 providing a Vd_offset voltage through a resistor R2. Typically R1=R2 is chosen to cancel any offset voltages from (undesired) current that may be drawn by the inputs to the operational amplifier 57. Additionally a feedback resistor (not shown) may optionally be added between the inverting input 54 and the output 53 of the operational amplifier to limit the gain of the circuit. The drain of T1 will arrive at a DC (steady state) voltage equal to the Vd_offset voltage value since any small deviation of the drain above or below this voltage will result in the operational amplifier transmitting an amplified voltage to the body of T1 31. Thus the input to the body terminal 31 of device T1 achieves the target Vt(=V_ref) for device T1 at a desired T1 drain voltage Vds, i.e., Vds=Voffset.

That is, in operation, the receiving current I_ref, charges up the drain of T1 (erg., to a positive voltage) which voltage Vin 52 is input to the non-inverting terminal of the differential op-amp 57. When Vin 52 exceeds Voffset, via the output 53 of op-amp 57, a voltage is provided that keeps the T1 body terminal 31 at a positive voltage (it is understood that for pFET devices the same principle applies however the voltage polarities are reversed). If initially the voltage at the drain 32 is below the Voffset voltage, then a negative voltage will be presented at Vout 53 by op-amp 57, causing the Vt of T1 to be very high, and the I_ref current will charge the drain of T1 positive. When the voltage at the drain of T1 exceeds Voffset, Vout 53 will become positive and in turn cause voltage at the body terminal 31 to grow, with a positive polarity. The positive voltage at the body terminal 31 tends to decrease the threshold voltage (ire., it lowers Vt) of T1. As voltage at the body terminal 31 keeps rising as the drain terminal charges, at one point, the Vt will become equal to V_ref and at that point, the transistor T1 will draw the I_ref current value as the device is now turned on at the desired V_ref threshold voltage, i.e., the drain terminal stops charging and, in steady state, the voltage at the body contact 31 is the voltage necessary to provide a target Vt(V=ref). The same voltage at the body terminal 3 1, which is the output voltage Vout 53 of the operational amplifier 57, may be applied to other transistor devices on the chip, so all like transistors will now have the same target Vt. That is, the voltage at the body terminal 31 (Vbs) can now be mirrored to other such nFETs in the circuit, thereby providing nFET with the target Vt.

In FIG. 3, it is understood that the device T1 whose threshold voltage Vt is being regulated may comprise a double-gated transistor device including a back-gate 33′, that, as is known, with a voltage applied thereat, may modulate the threshold voltage of the first gate 33 of T1. Thus, the circuit 50 depicted in FIG. 3 is applicable for providing a threshold voltage Vt regulation for a back-gated transistor device in the same manner as described for the body-bias device configuration depicted in FIGS. 2 and 3. That is, in operation, the drain 32 of the T1, receiving current I_ref, charges up the drain of T1 (e.g., to a positive voltage) which voltage is input to the non-inverting terminal of the differential op-amp 57 through resistor R1. Via the output 53 of op-amp 57, a voltage is provided at the T1 back gate that changes the threshold voltage of the first gate 33. Initially, the threshold voltage of T1 is above the V_ref voltage. The positive voltage at the back-gate decreases the device's threshold voltage (i.e., it lowers Vt of the first gate 33). As voltage at the body keeps rising as the drain charges, at one point, the Vt will become equal to V_ref and at that point, the drain stops charging as the transistor T1 now draws the I_ref current value as the device is now turned on at the desired V_ref threshold voltage, i.e., the drain terminal stops charging and, in steady state, the voltage at the back-gate is the voltage necessary to provide a target Vt(=V_ref). The same voltage at the back-gate, Vout 53, may be fed or distributed to back-gates of other like transistor devices on the die so they all have the same target Vt.

In both variations of FIG. 3 where nFET T1 is either a single gate 33 or double-gated 33, 33′ transistor device, it is understood that the effect of utilizing op-amp 57 enables Vt, with higher Vds, to be regulated. This is particularly important to the case of the CMOS logic where it may be required that the voltage Vt_sat (Vt at saturation) be regulated, i.e., regulate Vt_sat @ Vds=Vdd power supply voltage. In this case a boosted power supply may be included in the current source driving the drain of T1. Further, the configuration of the circuit in both embodiments enables the drain voltage of T1 to be any desirable voltage. Thus, Vt of T1 may be regulated with a very low drain voltage or high drain voltage depending upon the application. Thus, two attributes are being controlled according to the invention: the Vt of T1 and the Vd at the drain of T1.

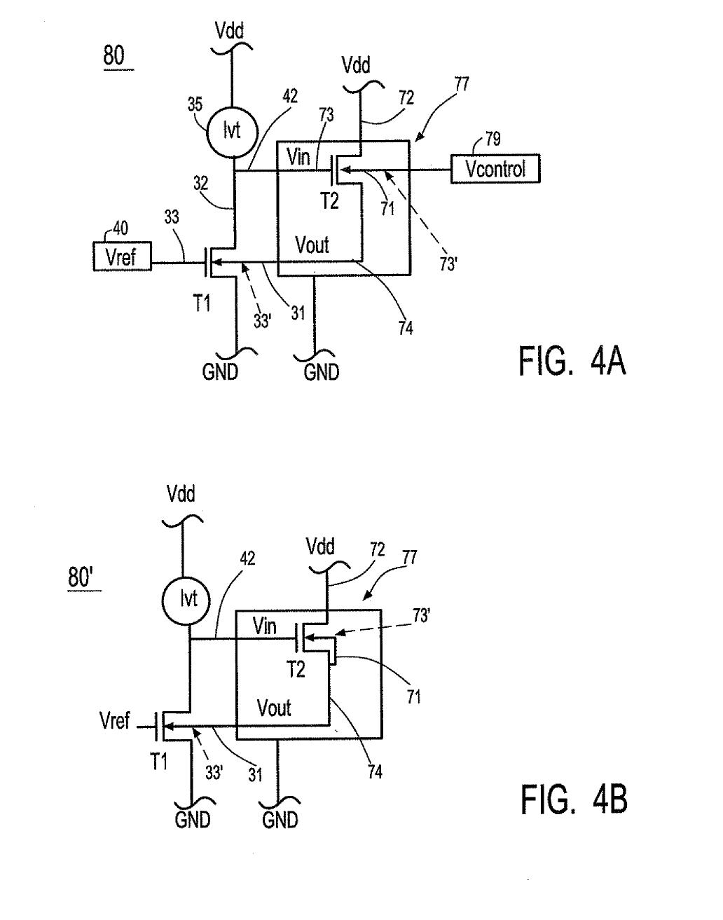

FIG. 4A depicts a further embodiment of the invention where the offset circuit 77 comprises a second MOS device, e.g., nMOS T2, in a source-follower configuration. In the embodiment depicted in FIG. 4A, a circuit 80 is provided for regulating threshold voltages in a CMOS FET device, the transistor T1, such as an nFET. As in the first embodiment depicted in FIG. 2, transistor T1 includes one terminal (e.g., a Source) connected to ground, one terminal (e.g., a Drain) 32 connected to a constant current source 35 providing a device threshold current I_ref current, and a gate terminal 33 connected to a voltage source 40 that is generated on-chip, providing a desired gate voltage threshold reference V_ref according to a desired application. The nFET T1 of FIG. 4A is body-contacted FET, and as in the other embodiments, is of dimensions W/L having its gate set at the target Vt(=V_ref) while the I_ref current source provides the threshold current value of approximately 300 nA×W/L that is forced into the drain/body connection of T1. In the embodiment of FIG. 4A, the offset circuit comprises a second nMOS device T2 having a drain terminal 72, a gate terminal 73 and a source terminal 74. The drain 72 of transistor T2 is connected with a power supply source Vdd. The gate 73 of transistor T2 is connected to drain terminal 32 of transistor T1, and the source terminal 74 of T2 is connected with the body terminal 31 of T1. The transistor T2 is additionally a body-contacted FET device and includes a body terminal 71 that is connected to a V_control voltage source 79 (e.g., a power supply) which is used to achieve a desired drain voltage on T1.

In the circuit operation of FIG. 4A, the drain 32 of the T1, receiving current I_ref, charges up the drain of T1 (e.g., to a positive voltage) which voltage is input at the gate 73 of T2 and will eventually turn on transistor T2 and, at which point, starts to pull the voltage of the T2 source terminal up. This action, in turn, raises the voltage at the T1 body terminal 51. It is understood that for pFET devices the same principle applies however the voltage polarities are reversed. Initially, the threshold voltage of T1 is above the V_ref voltage. The positive voltage at the body terminal 31 decreases the device's threshold voltage (i.e., it lowers Vt). As voltage at the body keeps rising as the T1 drain charges, at one point, the Vt of T1 will drop to a value equal to V_ref and at that point, the transistor T1 will draw the I_ref current value as the T1 device is now turned on at the desired V_ref threshold voltage, i.e., the drain terminal stops charging and, in steady state, the voltage at the body is the voltage necessary to provide a target Vt(=V_ref). The T1 drain voltage 42 is equal to the voltage at the body of T1 plus the Vt of transistor T2. Thus, by adjusting the threshold voltage (Vt) of device T2, then the drain voltage of T1 is adjustable as well. The Vt of T2 is adjustable due to the application of the V_control signal 79 at the body terminal 71 of transistor T2, which in turns, changes the steady state voltage at the drain of T1. The same voltage at the source terminal 74 of T2, may be applied to the body terminal of other transistor devices on the chip, so all transistors will now have the same target Vt. That is, the voltage at the body terminal 31 (Vbs) of device T1 can now be mirrored to other such nFETs in the circuit, thereby providing nFET with the target Vt.

FIG. 4B depicts an alternate embodiment of the invention that comprises a variation of the circuit 80 of FIG. 4A with transistors T1 and T2 in a modified circuit configuration 80′. In the circuit 80′ depicted in FIG. 4, the body terminal 71 of transistor device T2 is tied to its source terminal 74, which, in turn, is connected to the body terminal 33 of first nMOS device T1. In this configuration, the drain voltage 42 at device T1 is not configurable, but it is at a higher value than currently achievable in prior art designs, i.e., corresponding to the Vt voltage value (of T2) above the body voltage of T1, in particular the drain voltage of T1 is equal to the sum of the body voltage of T1 and the threshold voltages of T2 (with a body-to-source voltage of zero).

In the source-follower circuit configurations 80 and 80′ of respective FIGS. 4A and 4B, it is understood that the device T1 whose threshold voltage Vt is being regulated may comprise a double-gated transistor device including a back-gate 33′, and, that the second device T2 may additionally comprise a double-gated transistor device including a back-gate 73′ as optionally shown in respective FIGS. 4A and 4B. Thus, in the invention, with a voltage applied at a back gate 73′ of transistor device T2, the threshold voltage of the first gate 33 of T1 may be modulated. The circuits 80 and 80′ of respective FIGS. 4A and 4B are applicable for providing a threshold voltage Vt regulation for a back-gated transistor device in the same manner as described for the body-bias device configurations as described herein.

Furthermore, in the embodiment of FIG. 4A, it is understood that the effect of utilizing second transistor T2 enables a Vt with higher Vds to be regulated. In this case, a boosted power supply may optionally be included in the current source driving the drain of T2. Further, the configuration of the circuit 80 enables the drain voltage of T1 to be any desirable voltage. Thus, Vt of T1 may be regulated with a very low drain voltage or high drain voltage depending upon the application. Thus, two attributes are being controlled according to each of the embodiments of the invention: the Vt of T1 and the Vd at the drain of T1 by virtue of the V_control voltage applied at the body of T2 that enables this freedom of control over the drain voltage at the desired Vt.

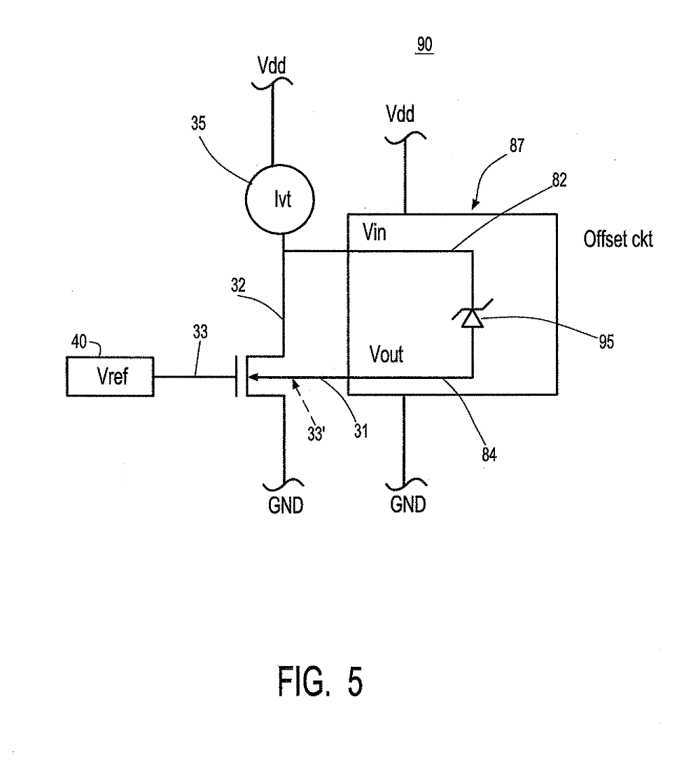

FIG. 5 depicts a further embodiment of the invention comprising a circuit 90 for regulating threshold voltage of a device T1 wherein the offset circuit 87 comprises a Zener diode 95. One terminal 82 of the Zener diode 95 is connected with the drain terminal 32 of T1 while the second terminal 84 of the Zener diode 95 is connected with the body terminal 31 of transistor device T1. The Zener diode configuration is shown in reverse bias configuration. In operation of the circuit 90 of FIG. 5, the drain 32 of the T1, receiving current I_ref from I_ref current source 35, charges up the drain of T1 (e.g., to a positive voltage) which voltage is input at the first terminal 82 of Zener diode 95. Initially, the threshold voltage of T1 is above the V_ref voltage. As voltage at the T1 drain builds, the voltage across the Zener diode builds as does the voltage at the body terminal 31 of device T1. The positive voltage at the body terminal 31 decreases the T1 device's threshold voltage (i.e., it lowers Vt). As voltage at the body keeps rising as the T1 drain charges, at one point, the voltage rise will trigger the Zener breakdown phenomena where current through the Zener diode 95 will be initiated. At or prior to the Zener breakdown point, the Vt of device T1 will drop to a value equal to V_ref and at that point, the transistor T1 will draw the I_ref current value as the T1 device is now turned on. That is, the drain terminal stops charging at the Zener breakdown voltage and, in steady state, the voltage at the body is the voltage necessary to provide a target Vt(=V_ref). The T1 drain voltage 42 is equal to the voltage at the body of T1 plus the Zener diode voltage. Thus, the value of the Zener diode breakdown voltage and the body bias voltage at transistor T1 determines the drain voltage at the T1 device independent of the Vt voltage modification.

The body voltage applied to transistor T1 in the circuit 90 of FIG. 5, may be applied to other similar transistor devices on the chip, so all transistors will now have the same target Vt.

It is understood that each of the various embodiments of the invention shown in FIGS. 2-5 and described herein may be incorporated in larger circuits such as provided in an integrated circuit, e.g., including memory devices, ASICs, and the like, and may be coupled to and/or operate in conjunction with other circuits and devices. Further, the devices described herein may be manufactured using current standard CMOS semiconductor lithographic techniques as would be known to skilled artisans or semiconductor device manufacturing techniques to be devised in the future.

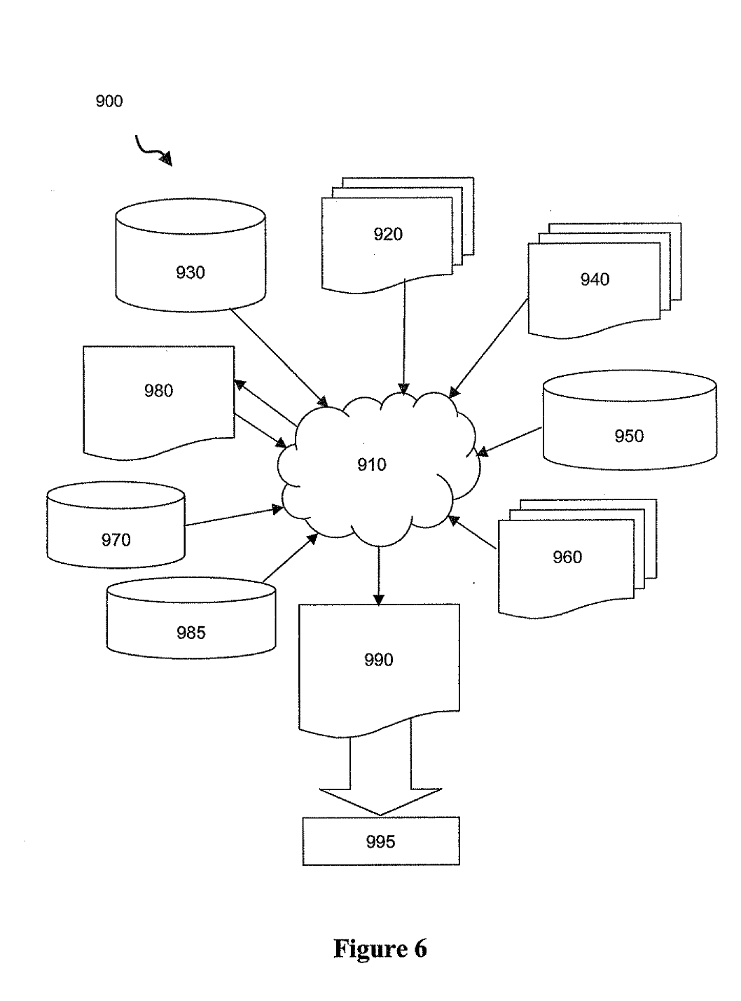

FIG. 6 shows a block diagram of an exemplary design flow 900 used for example, in semiconductor design, manufacturing, and/or test. Design flow 900 may vary depending on the type of IC being designed. For example, a design flow 900 for building an application specific IC (ASIC) may differ from a design flow 900 for designing a standard component. Design structure 920 is preferably an input to a design process 910 and may come from an IP provider, a core developer, or other design company or may be generated by the operator of the design flow, or from other sources. Design structure 920 comprises an embodiment of the invention as shown in FIGS. 2-5 in the form of schematics or HDL, a hardware-description language (e.g., Verilog, VHDL, C, etc.). Design structure 920 may be contained on one or more machine readable medium. For example, design structure 920 may be a text file or a graphical representation of an embodiment of the invention as shown in FIGS. 2-5. Design process 910 preferably synthesizes (or translates) an embodiment of the invention as shown in FIGS. 2-5 into a netlist 980, where netlist 980 is, for example, a list of wires, transistors, logic gates, control circuits, I/O, models, etc. that describes the connections to other elements and circuits in an integrated circuit design and recorded on at least one of machine readable medium. For example, the medium may be a CD, a compact flash, other flash memory, a packet of data to be sent via the Internet, or other networking suitable means. The synthesis may be an iterative process in which netlist 980 is resynthesized one or more times depending on design specifications and parameters for the circuit.

Design process 910 may include using a variety of inputs; for example, inputs from library elements 930 which may house a set of commonly used elements, circuits, and devices, including models, layouts, and symbolic representations, for a given manufacturing technology (e.g., different technology nodes, 32 nm, 45 nm, 90 nm, etc.), design specifications 940, characterization data 950, verification data 960, design rules 970, and test data files 985 (which may include test patterns and other testing information). Design process 910 may further include, for example, standard circuit design processes such as timing analysis, verification, design rule checking, place and route operations, etc. One of ordinary skill in the art of integrated circuit design can appreciate the extent of possible electronic design automation tools and applications used in design process 910 without deviating from the scope and spirit of the invention. The design structure of the invention is not limited to any specific design flow.

Design process 91 0 preferably translates an embodiment of the invention as shown in FIGS. 2-5, along with any additional integrated circuit design or data (if applicable), into a second design structure 990. Design structure 990 resides on a storage medium in a data format used for the exchange of layout data of integrated circuits and/or symbolic data format (e.g. information stored in a GDSII (GDS2), GL1, OASIS, map files, or any other suitable format for storing such design structures). Design structure 990 may comprise information such as, for example, symbolic data, map files, test data files, design content files, manufacturing data, layout parameters, wires, levels of metal, vias, shapes, data for routing through the manufacturing line, and any other data required by a semiconductor manufacturer to produce an embodiment of the invention as shown in FIGS. 2-5. Design structure 990 may then proceed to a stage 995 where, for example, design structure 990: proceeds to tape-out, is released to manufacturing, is released to a mask house, is sent to another design house, is sent back to the customer, etc.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

1. A design structure embodied in a machine readable medium, the design structure for regulating threshold voltage of a FET transistor device having gate, drain and source terminals and a body terminal, said design structure comprising:
a current source for providing a threshold current bias to said drain terminal of the FET device;
a first voltage source configured to supply a reference threshold voltage to the gate terminal of the FET device;
a circuit coupled to said FET device for enabling threshold voltage adjustment of said FET device, said coupled circuit including a first input connected to said drain terminal of said FET device for receiving a voltage at the drain terminal, and having an output for applying a voltage to said body terminal of said FET device in response to said voltage at said drain terminal, said applied voltage to said body enabling adjustment of a threshold voltage of said FET device at the reference threshold voltage, wherein a voltage at said drain terminal of the threshold voltage adjusted FET device is adjustable independent of said body applied voltage;
a distributing circuit for distributing said body bias voltage applied at said body terminal to other like FET devices provided in an integrated circuit so as to provide a uniform threshold voltage for each of the other like FET devices;
wherein said coupled circuit includes means for providing a body voltage at said FET device that is different from a drain voltage of said device, whereby a steady state direct current condition in said FET device results when said applied voltage at said body terminal renders the threshold voltage of said FET device equal to said reference threshold value applied at said gate terminal; and
the coupled circuit includes an operational amplifier comprising:
a first, non-inverting, terminal for receiving a voltage at said drain terminal receiving said threshold current bias;
a second, inverting, terminal connected to a second voltage source providing an offset voltage; and
an output terminal connected to said body terminal of said FET device for applying said body bias voltage to said body terminal of said FET device in response to voltage present at said drain terminal.

2. (canceled)

3. (canceled)

4. The design structure as claimed in claim 1, wherein said FET transistor device is a first FET device, said coupled circuit including a second FET device including a gate, drain and source terminals and, further including a body bias terminal wherein,
said gate terminal of said second FET device receives a voltage at said drain terminal receiving said threshold current bias;
said drain terminal of said second FET device is connected to a power supply voltage source; and
said source terminal of said second FET device is connected to said body terminal of said first FET device for applying said body bias voltage to said body terminal of said first FET device in response to said voltage present at said drain terminal; and,
said body terminal of said second FET device is connected to a control voltage source used to achieve a desired drain voltage at said first FET device when in said steady state direct current condition, wherein said second FET transistor is turned on by a voltage value at said drain terminal of said first FET transistor device greater than the threshold voltage of said second FET device as controlled by said control voltage applied at said body terminal of said second FET device, and, in response, said voltage at the source terminal of said second FET transistor increases the voltage applied at the body terminal of said first FET device for adjusting said threshold voltage, and wherein at a steady state direct current condition in said first FET device, a drain terminal voltage equals a value of said voltage at the body terminal of said first FET transistor device, plus the threshold voltage of said second PET transistor device, said drain voltage of said first FET device being adjustable due to adjusting said threshold voltage of said second FET device due to the application of the control voltage signal at the body terminal of said second FET transistor.

5. The design structure as claimed in claim 1, wherein said FET transistor device is a first FET device, said coupled circuit including a second FET device including a gate, drain and source terminals and, further including a body bias terminal wherein,
said gate terminal of said second FET device receives a voltage at said drain terminal receiving said threshold current bias;
said drain terminal of said second FET device is connected to a power supply voltage source providing an offset voltage; and
said source terminal of said second FET device is connected to said body terminal of said first FET device for applying said body bias voltage to said body terminal of said first FET device in response to said drain terminal voltage;
said source terminal of said second FET device is additionally connected to said body terminal of said second FET device, wherein said second FET transistor is turned on by a voltage value at said drain terminal of said first FET transistor device greater than the threshold voltage of said second PET device, and, in response, said voltage at the source terminal of said second FET transistor increases the voltage applied at the body terminal of said first FET device for adjusting said threshold voltage, wherein said coupled circuit includes a Zener diode device having a determined breakdown voltage, said Zener diode including a first terminal connected to said drain terminal of said FET device and including a second terminal connected to said body bias terminal, wherein a voltage across the Zener diode increases as said voltage at said drain terminal increases in response to received threshold current bias, and in response, said voltage at said body terminal of said FET device increases thereby decreasing the FET device's threshold voltage, and wherein at a steady state condition, the voltage at the drain terminal of said FET device is equal to the voltage at the body terminal of the FET device plus the Zener diode breakdown voltage, the value of the Zener diode breakdown voltage and the body bias voltage at said FET device determining the drain voltage at said FET device independent of the Vt voltage modification.

6. The design structure of claim 1, wherein the design structure comprises a netlist which describes the circuit, and wherein the design structure resides on a storage medium as a data format used for the exchange of layout data of integrated circuits (IC).

7. The design structure of claim 1, wherein the design structure includes at least one of test data files, characterization data, verification data, or design specifications.

8. A design structure embodied in a machine readable medium, the design structure for regulating threshold voltage of a first FET transistor device having gate, drain and source terminals and a body terminal, said design structure comprising:
a current source for providing a threshold current bias to said drain terminal of the first PET device;
a first voltage source configured to supply a reference threshold voltage to the gate terminal of the first FET device;
a second FET device coupled to said first FET device for enabling threshold voltage adjustment of said first FET device, said second FET device including a gate, drain and source terminals and, further including a body bias terminal wherein,
said gate terminal of said second FET device receives a voltage at said drain terminal of said first FET device receiving said threshold current bias;
said drain terminal of said second FET device is connected to a power supply voltage source providing an offset voltage;
said source terminal of said second FET device is connected to said body terminal of said first FET device for applying said body bias voltage to said body terminal of said first FET device in response to said voltage present at said drain terminal; and
said body terminal of said second FET device is connected to a control voltage source for supplying a voltage used to adjust a threshold voltage of said second FET device;
said second FET transistor turning on by a voltage value at said drain terminal of said first FET transistor device greater than a threshold voltage of said second FET device as adjusted by said applied control voltage, and, in response, said voltage at the source terminal of said second FET transistor increases the voltage applied at the body terminal of said first FET device for adjusting said threshold voltage of said first FET device;
wherein a voltage at said drain terminal of the threshold voltage adjusted FET device is adjustable independent of said applied voltage at said body terminal of said first FET device; and
wherein at a steady state direct current condition in said first FET device, a drain terminal voltage equals a value of said voltage at the body terminal of said first FET transistor device, plus the threshold voltage of said second FET transistor device, said drain voltage of said first FET device being adjustable in response to said threshold voltage adjustment of said second FET device due to the application of the control voltage signal at the body terminal of said second FET transistor.

9. The design structure as claimed in claim 8, wherein said body terminal of said second FET device is connected to said source terminal of said second FET device without application of voltage to said body terminal of said second FET device by said control voltage source, wherein at a steady state direct current condition in said first FET device, a drain terminal voltage of said first FET device equals a value of said voltage at the body terminal of said first BET transistor device, plus the threshold voltage of said second FET transistor device.

10. The design structure of claim 8, wherein the design structure comprises a netlist which describes the circuit, and wherein the design structure resides on a storage medium as a data format used for the exchange of layout data of integrated circuits (IC).

11. The design structure of claim 8, wherein the design structure includes at least one of test data files, characterization data, verification data, or design specifications.
